(19) United States
(12) Patent Application Publication
(10) Pub. No.: US 2012/0092493 A1
(43) Pub. Date: Apr. 19, 2012

(54) MONITORING SYSTEM

(76) Inventors: Syouta Tsutsui, Hitachinaka (JP); Tohru Kajiyama, Mito (JP); Hiroaki Arima, Hitachinaka (JP); Kenichi Sasaki, Mito (JP); Mitsunobu Sugimoto, Takizawa (JP); Masaki Kawamata, Mito (JP)

(21) Appl. No.: 13/213,516

(22) Filed: Aug. 19, 2011

(30) Foreign Application Priority Data
Sep. 27, 2010 (JP) 2010-214661

(51) Int. Cl. H04N 7/18

(52) U.S. Cl. 348/143; 348/E07.085

(57) ABSTRACT

In order to provide a monitoring system for performing monitoring efficiently using a small number of cameras in accordance with a crowded degree in a target region, a monitoring system, comprising: a movable monitoring camera; and a controlling unit for controlling the monitoring camera, wherein the controlling unit detects a target object in a target region, calculates a crowded degree of the target objects in the target region, moves the monitoring camera to a position of the target object so as to monitor the target object if the crowded degree is small, and makes the monitoring camera round so as to monitor the target objects if the crowded degree is large is provided.

### CROSS REFERENCE TO RELATED APPLICATION

This application claims priority under 35 U.S.C. §119 to Japanese Patent Application No. 2010-214661 filed on Sep. 27, 2010, the disclosure of which is incorporated herein by reference.

### BACKGROUND OF THE INVENTION

1. Field of the Invention

The present invention relates to a monitoring system for monitoring a target region in a room, or a vehicle, etc, and more particularly to a monitoring system for reducing blind spots at the time of imaging by moving a monitoring camera.

2. Description of the Related Art

In recent years, a railroad company intends to install monitoring cameras on ceilings, walls, and luggage racks in a railroad vehicle for recording and preventing a crime (e.g., a pickpocket, a molestation, or a terrorism) and a nuisance (e.g., a drunken person or a fight), for grasping a situation in the railroad vehicle, and for communicating with a person in the railroad vehicle in an emergency situation.

Also, having no relation with a railroad vehicle, JP 2002-027435 A discloses a monitoring system using a small number of cameras, comprising: a camera unit movable on a rail in a facility; and a sensor, wherein the camera unit moves to a place where an abnormal condition occurs so as to perform monitoring when the sensor detects the abnormal condition in the facility, and the camera unit monitors the whole facility when an abnormal condition does not occur.

However, an installation position and the number of the monitoring cameras are problematic when the monitoring camera is installed in a railroad vehicle. Also, since a crowded degree in the railroad vehicle changes depending on a time period and a line, a monitoring method suitable for the situation in the railroad vehicle is needed.

Also, a monitoring system using a conventional monitoring camera fixed to the ceiling, the wall, or the luggage rack in the railroad vehicle suffers from a problem of many blind spots in the railroad vehicle. For example, it is impossible to image a full face of a person whose back or side is toward the monitoring camera, and it is difficult to identify the person.

Therefore, in order to solve the above problem, it is necessary to increase the number of the fixed cameras.

Here, JP 2002-027435 A discloses that the small number of cameras perform monitoring by moving the camera unit. However, since methods for controlling the camera unit are not changed according to the crowded degree in the facility, there arises a problem that the same monitoring is performed regardless of the crowded degree.

An object of the present invention is to provide a monitoring system for performing monitoring efficiently using a small number of cameras in accordance with a crowded degree in a target region.

In addition, other objects and features of the present invention will be more apparent to those skilled in the art on consideration of the accompanying drawings and following specification.

### SUMMARY OF THE INVENTION

For example, the present invention provides a monitoring system, comprising: a movable monitoring camera; and a controlling unit for controlling the monitoring camera, wherein the controlling unit detects a target object in a target region, calculates a crowded degree of the target objects in the target region, moves the monitoring camera to a position of the target object so as to monitor the target object if the crowded degree is small, and makes the monitoring camera round so as to monitor the target objects if the crowded degree is large.

For example, in the case of a railroad vehicle, two rails are provided on a ceiling of the railroad vehicle in the longitudinal direction so as to install a plurality of the monitoring cameras.

Also, using an image recognition of images captured by a monitoring camera rounding on the rail or a fixed camera surveying the whole railroad vehicle, motion sensors fixed to a ceiling, a wall, or a luggage rack, etc. or a weight sensor provided under a seat, a person and an object are sensed, the monitoring camera on the rail is moved to a position of the person, and a high-priority monitoring is performed. When the person and the object is sensed, a (user-settable) predetermined value is set for a value of information (e.g., the number of the persons, etc) obtained by the image recognition and the sensors, and a round monitoring is performed if the value of the information is equal to or greater than the predetermined value. Also, when the door is opened and closed at a station, it is possible to move the monitoring camera to a position in front of a door of the railroad vehicle so as to monitor passengers getting on the railroad vehicle. Further, it is possible to remotely control the monitoring camera by a station staff or a conductor.

Even when the monitoring camera performs the round monitoring, if an emergency situation in which a loud voice is sensed or a fallen person is found, etc. occurs (image patterns of the emergency situation are stored in the monitoring camera), the round monitoring is changed to the high-priority monitoring, and the occurrence of the emergency situation is informed to the station staff and the conductor.

In addition, the above described structure is merely considered as an example, and various changes may be made without departing from the spirit and scope of the present invention. Also, other examples of the present invention will be apparent from the following detailed description and the accompanying drawings.

According to the present invention, it is possible to perform monitoring efficiently using a small number of cameras in accordance with a crowded degree in a target region. Also, it is possible to image a subject from not only one angle but also many angles by moving the monitoring camera, and is possible to reduce blind spots. Other effects of the present invention will be apparent from the following detailed description.

### BRIEF DESCRIPTION OF THE DRAWINGS

FIG. 1 is a view showing an example of a monitoring camera in a railroad vehicle;

FIG. 2 is a view showing a movement of the monitoring camera to image a full face of a person;

FIG. 3 is a view showing a movement of the monitoring camera when the railroad vehicle is not crowded;

FIG. 4 is a view showing a movement of the monitoring camera when the railroad vehicle is crowded; and

FIG. 5 is a block diagram of a monitoring system of the present invention.

### DETAILED DESCRIPTION OF THE PREFERRED EMBODIMENT

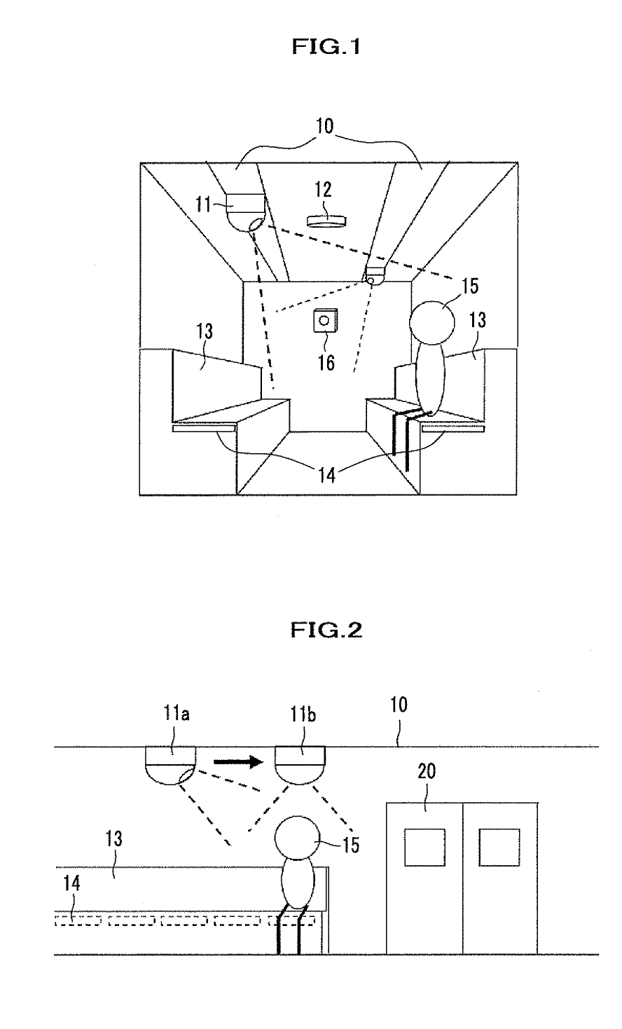

Referring to FIGS. 1-5, embodiments of the present invention will be explained in detail. In addition, the same or similar reference numbers are used to donate similar members in FIGS. 1-5, and detailed explanations are omitted.

Hereinafter, as one embodiment of the present invention, a monitoring system in a railroad vehicle will be explained.

FIG. 1 is a view showing an example of a monitoring camera in a railroad vehicle. In FIG. 1, a movable monitoring camera 11 is installed on a ceiling in the railroad vehicle which is a target region. Two rails 10 are provided on the ceiling of the railroad vehicle in the longitudinal direction so as to allow the monitoring camera 11 to move in the longitudinal direction.

A motion sensor 12 provided on the ceiling and a weight sensor 14 provided under a seat 13 detect a person 15 who is a target object in the railroad vehicle. Sensors are not limited to the motion sensor 12 and the weight sensor 14, and other sensors may be used to detect a person and an object. For example, a heat sensor may be attached to a strap so as to sense heat of a person when the person grasps the strap so that a position of the person can be specified. Also, the person 15 in the railroad vehicle can be detected by an image recognition of images captured by the monitoring camera 11 or a fixed camera 16. In addition, the target object is not limited to the person 15, and may be an object such as a luggage.

The monitoring camera 11 is moved to a position of a person based on the information obtained by the image recognition of the images captured by the motion sensor 12, the weight sensor 14 provided under the seat 13, the monitoring camera 11, and the fixed camera 16, and monitors the person.

Although two rails 10 are provided on the ceiling of the railroad vehicle in the longitudinal direction in FIG. 1, the rail 10 may be provided so as to round corners of the ceiling.

FIG. 2 is a view showing a movement of the monitoring camera to image a full face of a person. A monitoring camera 11a images a side face of the person 15. A conventional fixed camera can image only the side face in a positional relationship between the monitoring camera 11a and the person 15, and can hardly identify the person. However, in this embodiment, since the monitoring camera 11 is movable, it is possible to move a position of a monitoring camera 11b and to image a full face of the person. Also, a conventional fixed monitoring camera can image a subject from only one angle. However in the monitoring system of this embodiment, the subject can be imaged from many angles since the monitoring camera is movable. Also, even when the station staff and the conductor are at an office and a cab respectively and are not at a position of the monitoring camera 11 in the railroad vehicle, it is possible to freely move the monitoring camera 11 by remote controlling the monitoring camera 11.

According to this embodiment, it is possible to obtain more detailed information than that obtained by the conventional fixed camera, and to perform monitoring and grasping a situation in the railroad vehicle efficiently using a small number of cameras.

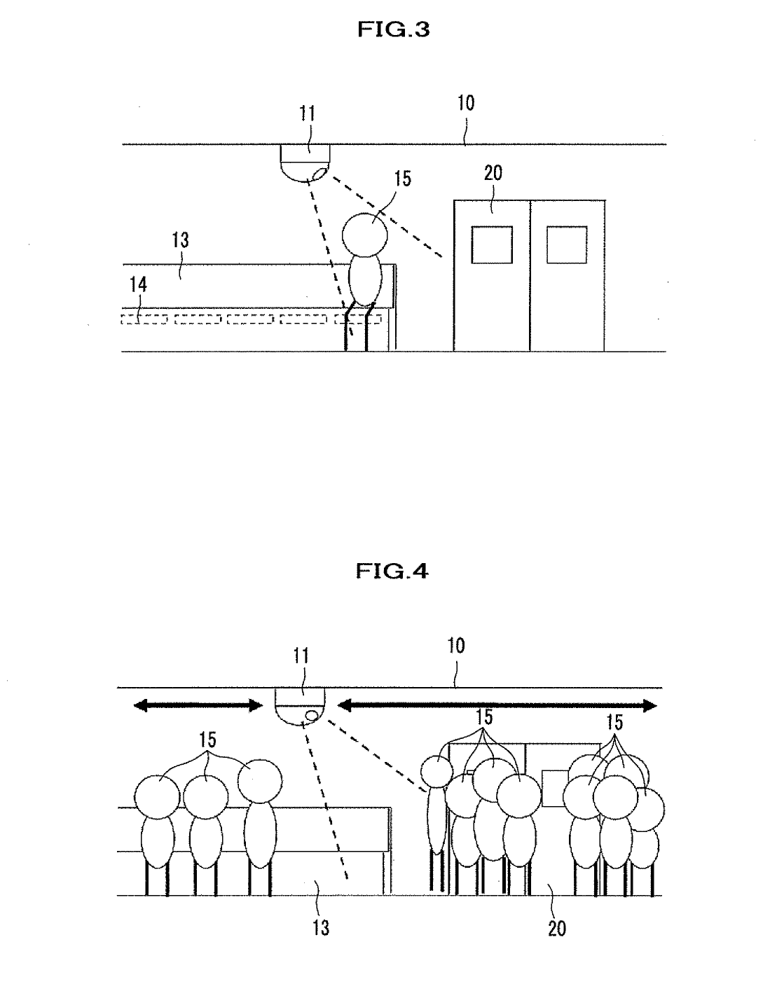

FIG. 3 is a view showing a movement of the monitoring camera 11 when the railroad vehicle is not crowded. When the railroad vehicle is not crowded (i.e., when the crowded degree is small), the monitoring camera 11 is moved to a position of the person 15 based on the information obtained by the image recognition of the images captured by the motion sensor 12, the weight sensor 14 provided under the seat 13, the monitoring camera 11, and the fixed camera 16, is stopped at the position, and performs a high-priority monitoring of the person 15. For this reason, for example, it is possible to perform monitoring of a sleeping person suffering from a pickpocket or a luggage lifting in an uncrowned situation. In addition, when the person 15 moves, it is also possible to make the monitoring camera 11 follow the person 15.

FIG. 4 is a view showing a movement of the monitoring camera 11 when the railroad vehicle is crowded. When the railroad vehicle is crowded as shown in FIG. 4 (i.e., when the crowded degree is large), the monitoring camera 11 always moves and rounds on the rail 10 so as to perform monitoring of the whole railroad vehicle since it is difficult to perform the high-priority monitoring as shown in FIG. 3.

Here, the timing at which the high-priority monitoring of the person 15 performed by the monitoring camera 11 is changed to the round monitoring is set by a user based on the information obtained by the image recognition of the images captured by the motion sensor 12, the weight sensor 14 provided under the seat 13, the monitoring camera 11, and the fixed camera 16. For example, the crowded degree is calculated based on the number of the target objects detected in the target region and is compared to a predetermined threshold value so as to determine whether to perform the high-priority monitoring or the round monitoring. For example, if the crowded degree is equal to or greater than a first threshold value, the round monitoring is performed, and if the crowded degree is less than the first threshold value, the high-priority monitoring is performed. Also, if the crowded degree is equal to or greater than the first threshold value, the monitoring may be changed to the round monitoring, and if the crowded degree is equal to or less than a second threshold value which is less than the first threshold value, the monitoring may be changed to the high-priority monitoring. In this case, while the crowded degree is between the first threshold value and the second threshold value, the current monitoring may be continued.

Also, when the round monitoring is performed, if the persons 15 are dispersed in the railroad vehicle, the monitoring camera 11 is moved slowly in the region where the person 15 is found, and is moved fast in the region where the person 15 is not found. For this reason, even when the persons 15 are unevenly distributed in the railroad vehicle, it is possible to make the monitoring camera 11 perform the high-priority monitoring in the region where the person 15 is found based on the information obtained by the image recognition of the images captured by the motion sensor 12, the weight sensor 14 provided under the seat 13, the monitoring camera 11, and the fixed camera 16. Also, it is possible to grasp the number of the persons 15 based on the information obtained by the image recognition of the images captured by the monitoring camera 11 and the fixed camera 16, and is possible to perform the monitoring in the region where the large number of the persons 15 are found using more monitoring cameras 11 than those used in the region where the small number of the persons 15 are found.

In addition, even if the railroad vehicle is crowded, and the monitoring camera 11 is always moved on the rail 10 so as to perform monitoring of the whole railroad vehicle, it is possible to move the monitoring camera 11 to a position in front of a door 20 of the railroad vehicle so as to monitor the persons 15 getting on the railroad vehicle when the door 20 is opened and closed at a station. Also, by storing a list of criminals in the monitoring system, it is possible to find a criminal getting on the railroad vehicle instantaneously so as to inform this situation to an user.

Also, if an emergency situation in which a loud voice is sensed or a fallen person is found, etc. occurs (image patterns of the emergency situation are stored in the monitoring camera), the round monitoring is changed to the high-priority monitoring, and the occurrence of the emergency situation is informed to the station staff and the conductor.

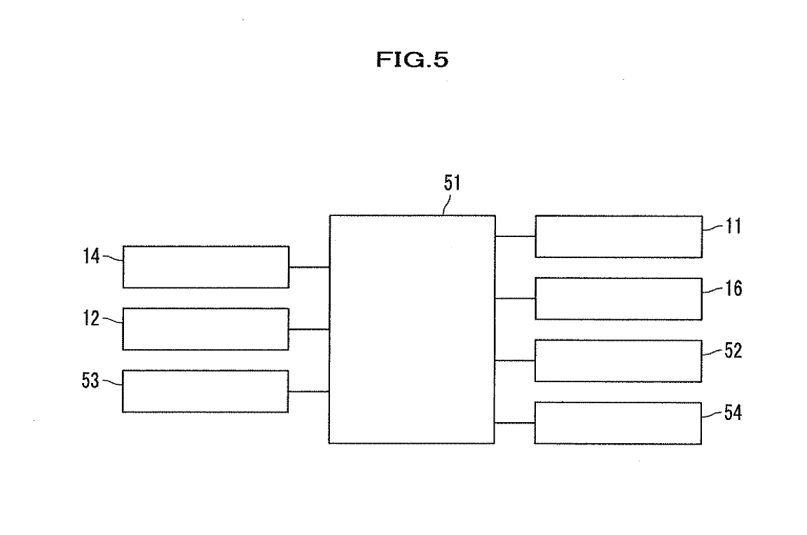

FIG. 5 is a block diagram of a monitoring system of the present invention. The monitoring system of this embodiment comprises a main system 51, a weight sensor 14, a motion sensor 12, a monitoring camera 11, a fixed camera 16, a rail driving device 52, a controller 53, and a monitor 54. Although only one weight sensor 14, one motion sensor 12, one monitoring camera 11, one fixed camera 16, one rail driving device 52, one controller 53, and one monitor 54 are illustrated in this block diagram, a plurality of the weight sensors 14, the motion sensors 12, the monitoring cameras 11, the fixed cameras 16, the rail driving devices 52, the controllers 53, and the monitors 54 may be included.

The weight sensor 14 is provided under a seat so as to detect weights of a person and a luggage, and the motion sensor 12 detects a position of a person based on an infrared radiated by the person.

The monitoring camera 11 and the fixed camera 16 can monitor the railroad vehicle, and can detect a position of a person in the railroad vehicle by performing an image recognition.

The monitor 54 is a device to check the images captured by the monitoring camera 11 and the fixed camera 16 at a place remote from the railroad vehicle.

The rail driving device 52 is a device to move the monitoring camera 11 to a specified position.

The controller 53 is a device to control the monitoring camera 11, the fixed camera 16, and the rail driving device 52 at a place remote from the railroad vehicle.

The main system 51 corresponds a controlling unit, calculates a suitable position for the monitoring camera 11 based on the information obtained by the weight sensor 14, the motion sensor 12, the monitoring camera 11, and the fixed camera 16, and controls the rail driving device 52. Also, the main system 51 performs a position correction by always feeding back the information from the monitoring camera 11 and the fixed camera 16. Also, based on the information from the weight sensor 14, the motion sensor 12, the monitoring camera 11, and the fixed camera 16, etc., the main system 51 detects target objects in the target region, and calculates a crowded degree of the target objects in the target region. If the crowded degree is small, the monitoring camera 11 is moved to a position of the target object so as to monitor it. If the crowded degree is large, the monitoring camera 11 is rounded so as to perform monitoring. As described above, the main system 51 controls the whole monitoring system. In addition, the image recognition of the images captured by the monitoring camera 11 and the fixed camera 16 may be performed by the main system 51, or may be performed by the monitoring camera 11 and the fixed camera 16 respectively so that the result of the image recognition is sent to the main system 51.

While embodiments of the present invention have been described, such description is for illustrative purpose only, and it is to be understood that changes and variations may be made without departing from the sprit of the present invention. Also, components of the embodiments may be combined unless a contradiction arises.

What is claimed is:

1. A monitoring system, comprising:
a movable monitoring camera; and
a controlling unit for controlling the monitoring camera,
wherein the controlling unit detects a target object in a target region, calculates a crowded degree of the target objects in the target region, moves the monitoring camera to a position of the target object so as to monitor the target object if the crowded degree is small, and makes the monitoring camera round so as to monitor the target objects if the crowded degree is large.

2. The monitoring system according to claim 1, wherein when a round monitoring is performed, the controlling unit moves the monitoring camera slowly in a region where the target object is found, and moves the monitoring camera fast in a region where the target object is not found.

3. The monitoring system according to claim 1, wherein the controlling unit moves the monitoring camera to a position in front of a door of the target region so as to image the target object getting in the target region when the door is opened and closed.

4. The monitoring system according to claim 1, wherein the controlling unit can remotely control the monitoring camera even when a user is not at a position of the monitoring camera.

5. The monitoring system according to claim 1, wherein the monitoring camera is moved on a rail provided on a ceiling or a wall.

6. The monitoring system according to claim 1, wherein the controlling unit detects the target object in the target region using any one of a motion sensor fixed to a ceiling, a wall, or a rack, a weight sensor provided under a seat, or an image recognition of images captured by the monitoring camera.

7. The monitoring system according to claim 1, wherein the target object is a person or an object.

8. The monitoring system according to claim 1, wherein the target region is a railroad vehicle.
